(19) United States
(12) Patent Application Publication
(10) Pub. No.: US 2007/0222858 A1
(43) Pub. Date: Sep. 27, 2007

(54) Monitoring system, monitoring method and program therefor

(75) Inventor: Masahiko Sugimoto, Saitama (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 11/723,659

(22) Filed: Mar. 21, 2007

(30) Foreign Application Priority Data
Mar. 27, 2006 (JP) JP2006-085709

(51) Int. Cl. H04N 7/18

(52) U.S. Cl. 348/143; 348/155

(57) ABSTRACT

A monitoring system being capable of monitoring the important monitoring region at a low cost is provided. The monitoring system according to the present invention includes: a first image-capturing section that captures a moving image in a first monitoring region; a second image-capturing section that captures a moving image in a second monitoring region adjacent to the first monitoring region in synchronism with capturing the image in the first monitoring region by the first image-capturing section; an image-capturing control section that matches an image-capturing condition of the first image capturing section with an image-capturing condition of the second capturing section, a composite image generating section that generates a composite image by adjusting a position at which a first frame image constituting the moving image captured by the first image-capturing section and a second frame image constituting the moving image captured by the second image-capturing section, respectively under the same image-capturing condition controlled by the image capturing control section based on a relative positional relationship between the first monitoring region by the first image-capturing section and the second monitoring region captured by the second image-capturing section; and a moving image storing section that stores therein the composite image generated by the composite image generating section as a frame image constituting a moving image in a partial monitoring region including at least a part of the first monitoring region and the second monitoring region.

### BACKGROUND

1. Field of the Invention

The present invention relates to a monitoring system, a monitoring method and a program therefor. Particularly, the present invention relates to a monitoring system that captures moving images in a monitoring region and a monitoring method, and a program for the monitoring system.

Cross Reference To Related Applications: the present application relates to and claims priority from a Japanese Patent Application No. 2006-085709 filed in Japan on Mar. 27, 2006, the contents of which are incorporated herein by reference for all purpose if applicable in the designated state.

2. Field of the Invention

A security system, has been disclosed as, for example, in Japanese Patent Application Publication No.2002-335492, that includes the steps of: storing a subject in a normal state as a reference image; comparing the captured image with the reference image per the corresponding pixel; setting the compressibility ratio of an image compression processing to a relatively low rate and recoding the same on a recording medium when it is conformed that the captured image is changed as the result of comparison; and setting the compressibility ratio of an image compression processing to a relatively high rate and recoding the same on a recording medium when it is confirmed that the captured image is not changed.

However, in the above-described security system which is based on the captured image, the resolution of the captured image is reduced as the range of the subject is enlarged, and then it is difficult to specify whether the person who is shown on the captured image is a suspicious person as the resolution of the captured image is reduced. While, if an image-capturing device with a high resolution is employed, the cost for the security system will be increased.

Thus, the advantage of the present invention is to provide a monitoring system, a monitoring method and a program therefor which are capable of solving the problem accompanying the conventional art. The above and other advantages can be achieved by combining the features recited in independent claims. Then, dependent claims define further effective specific example of the present invention.

### SUMMARY

In order to solve the above described problems, a first aspect of the present invention provides a monitoring system. The monitoring system includes: a first image-capturing section that captures a moving image in a first monitoring region; a second image-capturing section that captures a moving image in a second monitoring region adjacent to the first monitoring region in synchronism with capturing the image in the first monitoring region by the first image-capturing section; an image-capturing control section that matches an image-capturing condition of the first image capturing section with an image-capturing condition of the second capturing section; a composite image generating section that generates a composite image by adjusting a position at which a first frame image constituting the moving image captured by the first image-capturing section and a second frame image constituting the moving image captured by the second image-capturing section, respectively under the same image-capturing condition controlled by the image capturing control section based on a relative positional relationship between the first monitoring region by the first image-capturing section and the second monitoring region captured by the second image-capturing section; and a moving image storing section that stores therein the composite image generated by the composite image generating section as a frame image constituting a moving image in a partial monitoring region including at least a part of the first monitoring region and the second monitoring region.

The monitoring system may further include a characteristic region specifying section that specifies a characteristic region in the whole monitoring region including the first monitoring region and the second monitoring region based on the moving image captured by each of the first image-capturing section and the second image-capturing section, and an image-capturing condition determining section that determines the image capturing condition of the first image-capturing section and the second image capturing section based on the image in the characteristic region specified by the characteristic region specifying section. The image-capturing control section may cause the first image-capturing section and the second image capturing section to capture moving images under the image capturing condition determined by the image-capturing condition determining section.

The characteristic region specifying section may specify a movement region which is moving as a characteristic region based on the moving image captured by each of the first image-capturing section and the second image capturing section. The image-capturing condition determining section may determine an exposure condition of each of the first image-capturing section and the second image-capturing section based on the first frame image of the first monitoring region captured by the first image-capturing section, which includes the movement region specified by the characteristic region specifying section. The image-capturing control section may cause the first image-capturing section and the second image-capturing section under the exposure condition determined by the image-capturing condition determining section.

The characteristic region specifying section may specify the movement region which is most widely moving when there are a plurality of movement regions in the whole monitoring region. The image-capturing condition determining section determines the exposure condition of the first image-capturing section and the second image-capturing section based on the first frame image of the first monitoring region captured by the first image-capturing section, which includes the movement region specified by the characteristic region specifying section. The image-capturing control section may cause the first image-capturing section and the second image-capturing section to capture moving images under the exposure condition determined by the image-capturing condition determining section.

The characteristic region specifying section may specify a person region in which there is any person as a characteristic region based on the moving image captured by each of the first image-capturing section and the second image-capturing section. The image-capturing condition determining section may determine the exposure condition of the first image-capturing section and the second image-capturing section based on the first frame image of the first monitoring region captured by the first image-capturing section, which includes the person region specified by the characteristic region specifying section. The image capturing control section may cause the first image capturing section and the second image capturing section to capture moving images under the exposure condition determined by the image-capturing condition determining section.

When there are a plurality of person regions in the whole monitoring region, the characteristic region specifying section may specify the person region in which the ratio of the person's area to the whole monitoring region is largest. The image-capturing condition determining section may determines the exposure condition of the first image-capturing section and the second image-capturing section based on the first frame in the first monitoring region captured by the first image-capturing section, which includes the person region specified by the characteristic region specifying section. The image-capturing control section may cause the first image capturing section and the second image capturing section to capture moving image under the exposure condition determined by the image-capturing condition determining section.

The monitoring system may further include a facial region extracting section that extracts a facial region on which the face of a person is shown in the whole monitoring region based on the moving image captured by each of the first image capturing section and the second image capturing section and a facial region brightness determining section that determines the brightness of the facial region extracted by the facial region extracting section. The characteristic region specifying section may specify the person region in which the brightness of the person determined by the facial region brightness determining section is within a predetermined value. The image-capturing condition determining section may determine the exposure condition of the first image-capturing section and the second image-capturing section based on the first frame image captured by the first image-capturing section, which includes the person region specified by the characteristic region specifying section. The image-capturing control section may cause the first-image capturing section and the second image-capturing section to capture moving images under the exposure condition determined by the image-capturing condition determining section.

The monitoring system may further include a trimming section that trims the composite image generated by the composite image generating section with an aspect ratio the same as that of the first frame image captured by the first image-capturing section or the second frame image captured by the second image-capturing section to extract a partial monitoring region image. The moving image storage section may store the partial monitoring region image extracted by the trimming section as a frame image constituting a moving image of the partial monitoring region.

The monitoring system may further include a trimming section that trims the composite image generated by the composite image generating section with an aspect ratio the same as that of the frame image constituting a moving image reproduced by an external image reproducing apparatus to extract a partial monitoring region image. The moving image storage section my store the partial monitoring region image extracted by the trimming section as a frame image constituting a moving image in the partial monitoring region.

The monitoring system may further include a moving image compression section that compresses the plurality of partial monitoring region images extracted by the trimming section into a moving image as frame images constituting the moving image. The moving image storage section may store the plurality of partial monitoring region images compressed by the moving image compression section as frame images constituting a moving image in the partial monitoring region.

The monitoring system may further include an image processing section that alternately performs an image processing on a first frame image read from a plurality of light receiving elements included in the first image-capturing section and a second frame image read from a plurality of light receiving elements included in the second image-capturing section and stores the same in a memory.

The image processing section may include an AD converting section that alternately converts the first frame image read from the plurality of light receiving elements included in the first image-capturing section and the second frame image read from the plurality of light receiving elements included in the second image-capturing section to digital data. The composite image generating section may adjust a position at which the first frame image converted to the digital data by the AD converting section and the second frame image converted to the digital data by the AD converting section are combined.

The image processing section may include an image data converting section that alternately converts image data of the first frame image read from the plurality of light receiving elements included in the first image capturing section and image data of the second forme image read from the plurality of light receiving elements included in the second image-capturing section to display image data. The composite image generating section may generate a composite image by adjusting a position at which the first frame image converted to the display image data by the image data converting section and the second frame image converted to the display image data are combined.

A second aspect of the present invention provides a monitoring method. The monitoring method includes the steps of: capturing a moving image in a first monitoring region; capturing a moving image in a second monitoring region adjacent to the first monitoring region in synchronism with capturing the image in the first monitoring region by the first image-capturing section; matching an image-capturing condition of the first image capturing step with an image-capturing condition of the second image-capturing step; generating a composite image by adjusting a position at which a first frame image constituting the moving image captured by the first image-capturing step and a second frame image constituting the moving image captured by the second image-capturing step, respectively under the same image-capturing condition controlled by the image-capturing control step based on a relative positional relationship between the first monitoring region captured by the first image capturing step and the second monitoring region captured by the second image-capturing step; storing therein the composite image generated by the composite image generating step as a frame image constituting a moving image in a partial monitoring region including at least a part of the first monitoring region and the second monitoring region.

A third aspect of the present invention includes a program for a monitoring system that captures moving images. The program operates the monitoring system to function as: a first image-capturing section that captures a moving image in a first monitoring region; a second image-capturing section that captures a moving image in a second monitoring region adjacent to the first monitoring region in synchronism with capturing the image in the first monitoring region by the first image-capturing section; an image-capturing control section that matches an image-capturing condition of the first image capturing section with an image-capturing condition of the second capturing section; a composite image generating section that generates a composite image by adjusting a position at which a first frame image constituting the moving image captured by the first image-capturing section and a second frame image constituting the moving image captured by the second image-capturing section, respectively under the same image-capturing condition controlled by the image capturing control section based on a relative positional relationship between the first monitoring region by the first image-capturing section and the second monitoring region captured by the second image-capturing section, and a moving image storing section that stores therein the composite image generated by the composite image generating section as a frame image constituting a moving image in a partial monitoring region including at least a part of the first monitoring region and the second monitoring region.

A fourth aspect of the present invention provides a monitoring system. The monitoring system includes: a first image-capturing section that captures a moving image in a first monitoring region; a second image-capturing section that captures a moving image in a second monitoring region adjacent to the first monitoring region in synchronism with capturing the image in the first monitoring region by the first image-capturing section; a composite image generating section that generates a composite image by adjusting a position at which a first frame image constituting the moving image captured by the first image-capturing section and a second frame image constituting the moving image captured by the second image-capturing section, respectively under the same image-capturing condition controlled by the image capturing control section based on a relative positional relationship between the first monitoring region captured by the first image-capturing section and the second monitoring region captured by the second image-capturing section; a characteristic region specifying section that specifies a characteristic region in the composite image by analyzing the composite image generated by the composite image generating section; a trimming section that trims a characteristic region image which is an image in the characteristic region specified by the characteristic region specifying section from the composite image generated by the composite image generating section to extract the same; and a moving image storing section that stores therein the characteristic region image extracted by the trimming section as a frame image constituting the moving image in a partial monitoring region including at least a part of the first monitoring region and the second monitoring region.

The characteristic region specifying section may specify a movement region which is moving in the composite image by analyzing a plurality of continuous composite images generated by the composite image generating section. The trimming section may trim a movement region image which is an image of the movement region specified by the characteristic region specifying section to extract the same. The moving image storing section may store the movement region image extracted by the trimming section as a frame image constituting a moving image in the partial monitoring region.

The characteristic region specifying section may specify a person region in which there is any person in the composite image by analyzing the composite image generated by the composite image generating section. The trimming section may trim a person region image which is an image of the person region specified by the characteristic region specifying section from the composite image generated by the composite image generating section to extract the same. The moving image storage section may store the person region image extracted by the trimming section as a frame image constituting the moving image in the partial monitoring region.

The trimming section may trim a characteristic region image of which aspect ratio is the same as that of the first frame image captured by the first image-capturing section or the second frame image captured by the second image-capturing section from the composite image generated by the composite image generating section. The moving image storing section may store the characteristic region image extracted by the trimming section as a frame image constituting a moving image in the characteristic region.

The trimming section may trim a characteristic region image of which aspect ratio is the same as that of a frame image constituting a moving image reproduced by an external image reproducing apparatus from the composite image generated by the composite image generating section to extract the same. The moving image storage section may store the characteristic region image extracted by the trimming section as a frame image constituting a moving image in the characteristic region.

The monitoring system may further include a moving image compression section that compresses a plurality of characteristic region images extracted by the trimming section into a moving image as frame images constituting the moving image. The moving image storage section may store the plurality of characteristic region images compressed by the moving image compression section as frame images constituting the moving image in the characteristic region.

The monitoring system may further include an image processing section that alternately performs an image processing on a first frame image read from a plurality of light receiving elements included in the first image-capturing section and a second frame image read from a plurality of light receiving elements included in the second-image capturing section and stores the same in a memory.

The image processing section may include an AD converting section that alternately converts the first frame image read from the plurality of light receiving elements included in the first image-capturing section and the second frame image read from the plurality of light receiving elements included in the second image capturing section to digital data. The composite image generating section may generate a composite image by adjusting a position at which the first frame image converted to the digital data by the AD converting section and the second frame image converted to the digital data by the AD converting section are combined.

The image processing section may include an image data converting section that alternately converts image data of the first frame image read from a plurality of light receiving elements included in the first image-capturing section and image data of the second frame image read from a plurality of light receiving elements included in the second image capturing section to display image data. The composite image generating section may generate a composite image by adjusting a position at which the first frame image converted to the display image data by the image data converting section and the second frame image converted to the display image data by the image data converting section are combined.

A fifth aspect of the present invention provides a monitoring method. The monitoring method includes the steps of: capturing a moving image in a first monitoring region; capturing a moving image in a second monitoring region adjacent to the first monitoring region in synchronism with capturing the image in the first monitoring region by the first image-capturing step; generating a composite image by adjusting a position at which a first frame image constituting the moving image captured by the first image-capturing step and a second frame image constituting the moving image captured by the second image-capturing step, respectively based on a relative positional relationship between the first monitoring region by the first image capturing step and the second monitoring region captured by the second image-capturing step; specifying a characteristic region in the composite image by analyzing the composite image generated by the composite image generating step; trimming a characteristic region image which is an image in the characteristic region specified by the characteristic region specifying step from the composite image generated by the composite image generating step to extract the same; and storing the characteristic region image extracted by the trimming step as a frame image constituting the moving image in a partial monitoring region including at least a part of the first monitoring region and the second monitoring region.

A sixth aspect of the present invention provides a program for a monitoring system that captures moving images. The program operates the monitoring system to function as, a first image-capturing section that captures a moving image in a first monitoring region; a second image-capturing section that captures a moving image in a second monitoring region adjacent to the first monitoring region in synchronism with capturing the image in the first monitoring region by the first image-capturing section; an image-capturing control section that matches an image-capturing condition of the first image capturing section with an image-capturing condition of the second capturing section, a composite image generating section that generates a composite image by adjusting a position at which a first frame image constituting the moving image captured by the first image-capturing section and a second frame image constituting the moving image captured by the second image-capturing section, respectively under the same image-capturing condition controlled by the image capturing control section based on a relative positional relationship between the first monitoring region by the first image-capturing section and the second monitoring region captured by the second image-capturing section; and a moving image storing section that stores therein the composite image generated by the composite image generating section as a frame image constituting a moving image in a partial monitoring region including at least a part of the first monitoring region and the second monitoring region.

A seventh aspect of the present invention provides a monitoring system. The monitoring system includes. a first image-capturing section that captures a moving image in a first monitoring region; a second image-capturing section that captures a moving image in a second monitoring region adjacent to the first monitoring region in synchronism with capturing the image in the first monitoring region by the first image-capturing section; a characteristic region specifying section that specifies a characteristic region in the whole monitoring region including the first monitoring region and the second monitoring region based on the moving image captured by each of the first image capturing section and the second image capturing section; a trimming section that trims a plurality of characteristic region images including the plurality of characteristic regions specified by the characteristic region specifying section, respectively from the first frame image constituting the moving image captured by the first image-capturing section or the second frame image constituting the moving image captured by the second image-capturing section, respectively from the first frame image constituting the moving image captured by the first image-capturing section or the second frame image constituting the moving image captured by the second image-capturing section to extract the same; a composite image generating section that generates a composite image obtained by combining the plurality of characteristic region images extracted by the trimming section; and a moving image storage section that stores the composite image generated by the composite image generating section as a flame image constituting the moving image in a partial monitoring region including at least a part of the first monitoring region and the second monitoring region.

The characteristic region specifying section specifies a movement region which is moving as a characteristic region based on the moving image captured by each of the first image-capturing section and the second image-capturing section. The trimming section may trim the movement region image which is an image including the plurality of movement regions specified by the characteristic region specifying section from the first frame image constituting the moving image captured by the first-image capturing section or the second frame image constituting the moving image captured by the second-image capturing section to extract the same.

The characteristic region specifying section may specify a person in which there is any person based on the moving image captured by each of the first image-capturing section and the second image-capturing section. The trimming section may trim a person region image which is an image including the plurality of person regions specified by the characteristic region specifying section from the first frame image constituting the moving image captured by the first image-capturing section or the second frame image constituting the moving image captured by the second image-capturing section to extract the same.

The trimming section may trim the characteristic region image including the characteristic region specified by the characteristic region specifying section such that the composite image generated by the composite image generating section, of which aspect ratio is same as that of the first frame image captured by the first image-capturing section or the second frame image captured by the second image-capturing section to extract the same. The moving image storage section may store the partial monitoring region image extracted by the trimming section as a frame image constituting the moving image in the partial monitoring region.

The trimming section may trim a characteristic region image including the characteristic region specified by the characteristic region specifying section such that the composite image generated by the composite image generating section, of which aspect ratio is the same as that of a frame image constituting a moving image reproduced by an external image reproducing apparatus to extract the same. The moving image storage section may store the partial monitoring region image extracted by the trimming section as a frame image constituting the moving image in the partial monitoring region.

The monitoring system may further include a moving image compression section that compresses a plurality of characteristic region images extracted by the trimming section as a frame image constituting the moving image. The moving image storage section may store the plurality of composite images compressed by the moving image compression section as a frame image constituting the moving image in the partial monitoring region.

The monitoring system may fisher include an image processing section that alternately performs an image processing on a first forme image read from a plurality of light receiving elements included in the first image-capturing section and a second fame image read from a plurality of light receiving elements included in the second image-capturing section and stores the same in a memory.

The image processing section may include an AD converting section that alternately converts the first frame image read from the plurality of light receiving elements included in the first image-capturing section and the second frame image read from the plurality of light receiving elements included in the second image-capturing section to digital data. The characteristic region specifying section may specify the characteristic region based on the first frame image and the second frame image converted to the digital data by the AD converting section.

The image processing section may include an image data converting section that alternately convert image data of the first frame image read from the plurality of light receiving elements included in the first image-capturing section and image data of the second frame image read from the plurality of light receiving elements included in the second image-capturing section to display image data. The characteristic region specifying section may specify the characteristic region based on the first frame image and the second flume image converted to the display image data by the image data converting section.

An eighth aspect of the present invention provides a monitoring method. The monitoring method includes: capturing a moving image in a first monitoring region; capturing a moving image in a second monitoring region adjacent to the first monitoring region in synchronism with capturing the image in the first monitoring region by the first image-capturing section; specifying a characteristic region in the whole monitoring region including the first monitoring region and the second monitoring region based on the moving image captured by each of the first image capturing step and the second image capturing step, trimming a plurality of characteristic region images including the plurality of characteristic regions specified by the characteristic region specifying step, respectively from the first frame image constituting the moving image captured by the first image-capturing step or the second frame image constituting the moving image captured by the second image-capturing step, respectively; generating a composite image obtained by combining the plurality of characteristic region images extracted by the trimming step, and storing the composite image generated by the composite image generating step as a frame image constituting the moving image in a partial monitoring region including at least a part of the first monitoring region and the second monitoring region.

A ninth aspect of the present invention provides a program for a monitoring system that captures moving images. The program operates the monitoring system to function as: a first image-capturing section that captures a moving image in a first monitoring region; a second image-capturing section that captures a moving image in a second monitoring region adjacent to the first monitoring region in synchronism with capturing the image in the first monitoring region by the first image-capturing section; a characteristic region specifying section that specifies a characteristic region in the whole monitoring region including the first monitoring region and the second monitoring region based on the moving image captured by each of the first image capturing section and the second image capturing section; a trimming section that trims a plurality of characteristic region images including the plurality of characteristic regions specified by the characteristic region specifying section, respectively from the first frame image constituting the moving image captured by the first image-capturing section or the second frame image constituting the moving image captured by the second image-capturing section, respectively from the first frame image constituting the moving image captured by the first image-capturing section or the second frame image constituting the moving image captured by the second image-capturing section to extract the same; a composite image generating section that generates a composite image obtained by combining the plurality of characteristic region images extracted by the trimming section; and a moving image storage section that stores the composite image generated by the composite image generating section as a frame image constituting the moving image in a partial monitoring region including at least a part of the first monitoring region and the second monitoring region.

Here, all necessary features of the present invention are not listed in the summary of the invention The sub-combinations of the features may become the invention.

According to the present invention, a monitoring system being capable of monitoring the important monitoring region at a low cost.

### BRIEF DESCRIPTION OF THE DRAWINGS

FIG. 1 shows an example of environment for the usage of a monitoring system 100;

FIG. 2 shows an example of operation blocks in a trimming mode;

FIG. 3 shows an example of image capturing process in a monitoring region;

FIG. 4 shows an example of processing to trim characteristic region images from composite images;

FIG. 5 shows an example of processing to match image capturing condition,

FIG. 6 shows an example of operation blocks in a connecting mode;

FIG. 7 shows an example of frame image generated in the connecting mode;

FIG. 8 shows an example of flow chart of selecting an operation mode to generate a frame image, and

FIG. 9 shows an example of hardware configuration of a monitoring apparatus 110.

### DESCRIPTION OF EXEMPLARY EMBODIMENTS

Hereinafter, the present invention will now be described through preferred embodiments. The embodiments do not limit the invention according to claims and all combinations of the features described in the embodiments are not necessarily essential to means for solving the problems of the invention.

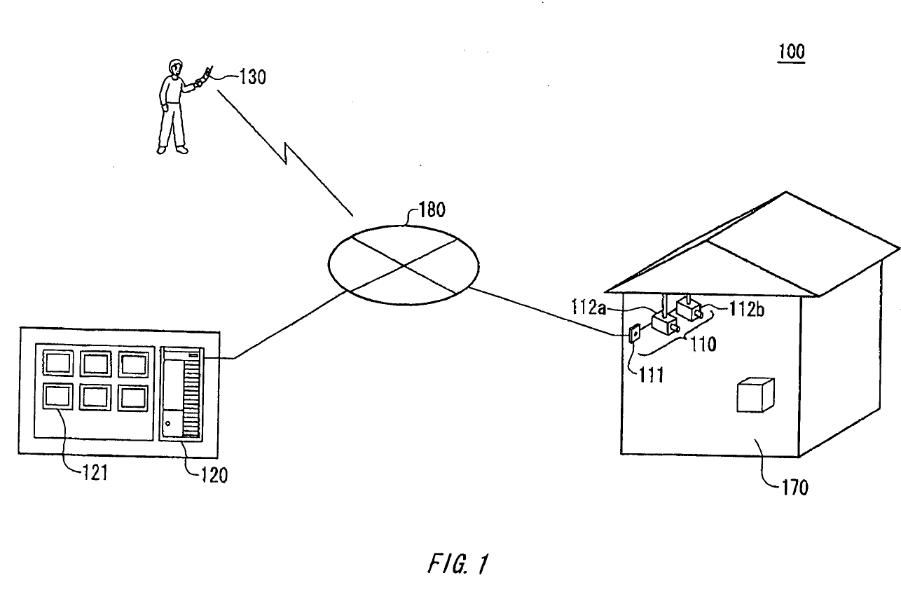

FIG. 1 shows an example of environment for the usage of a monitoring system 100 according to an embodiment of the present invention. The monitoring system 100 includes a monitoring apparatus 110, an image reproducing apparatus 120, and a mobile terminal 130. The monitoring apparatus 110 captures a monitoring region 170, generates frame images of a moving image and transmits the same to the image reproducing apparatus 120 installed in such as a monitoring center and the mobile terminal 130 held by a janitor in the monitoring region 170. The monitoring apparatus 110 includes a plurality of cameras 112a and 112b (hereinafter generally referred to as 112) that capture moving images in the monitoring region 170, and an image generating apparatus 111 that sequentially receives image-capturing data from the cameras 112a and 112b and converts the same to image data.

The cameras 112a and 112b capture different image-capturing ranges in the image-capturing monitoring region 170. At least a part of the image-capturing regions of the cameras 112a and 112b may be overlapped. Then, the image generating apparatus 111 specifies an overlapped image-capturing region over which both of camera 112a and camera 112b capture, and combine an image capturing region other than the overlapped image-capturing region by the camera 112b and an image captured by the camera 112a to generate a composite image. Then, the image generating apparatus 111 trims an image region including any person and an image region on which any moving subject is shown from the composite image to generate one frame image, and transmits the same to the image reproducing apparatus 120. At this time, the monitoring apparatus 110 trims with an aspect ratio for capturing by the camera 112a or 112b, or an aspect ratio of an image to be displayed on a display 121 such as a monitor by the image reproducing apparatus 120.

Here, the frame image may be captured under the image capturing condition such that the image capturing condition of the camera 112b is matched with that of the camera 112a which captures the important partial region as a monitoring target such as a partial region including any parson and a partial region including a moving object in frame images captured by the cameras 112a and 112b.

Here, the monitoring apparatus 110 may have not only a trimming mode which is an operation mode in which the important part is trimmed from a composite image obtained by combining images by the plurality of cameras 112 to generate a frame image, as described above but also a connecting mode which is an operation mode in which a plurality of partial regions being important as a monitoring target are trimmed from each of the frame images captured by the plurality of cameras 112 and connects the trimmed partial regions each other as one frame image to generate the one frame image. Here, in the connecting mode, a frame image with an aspect ratio the same as that of the frame image in the trimming mode may be generated.

According to the monitoring system 100 as described above, the plurality of cheap cameras 112 with low resolution are used instead of any camera with a high resolution, so that a monitoring region in a wide range can be efficiently monitored. For example, if it is required to monitor a horizontally long monitoring region, a plurality of cameras 112 are horizontally arranged, so that a monitoring image with an appropriate resolution for each monitoring region can be obtained. Additionally, since image capturing dada of the plurality of cameras is processed by the shared image generating apparatus 111, moving images can be generated at a low cost in comparison with the case that each of the cameras 112 processes images.

Here, the monitoring apparatus 110 may transmit the captured image to the image reproducing apparatus 120 or the mobile terminal 130 through a communication line 180 such as Internet. Additionally the image reproducing apparatus 120 may be an apparatus such as a computer being capable of receiving a moving image and reproducing the same. The mobile terminal 130 may be a cellular phone and a PDA. The image reproducing apparatus 120 may be disposed in a monitoring center far from the monitoring region 170 and also may be disposed near the monitoring region 170.

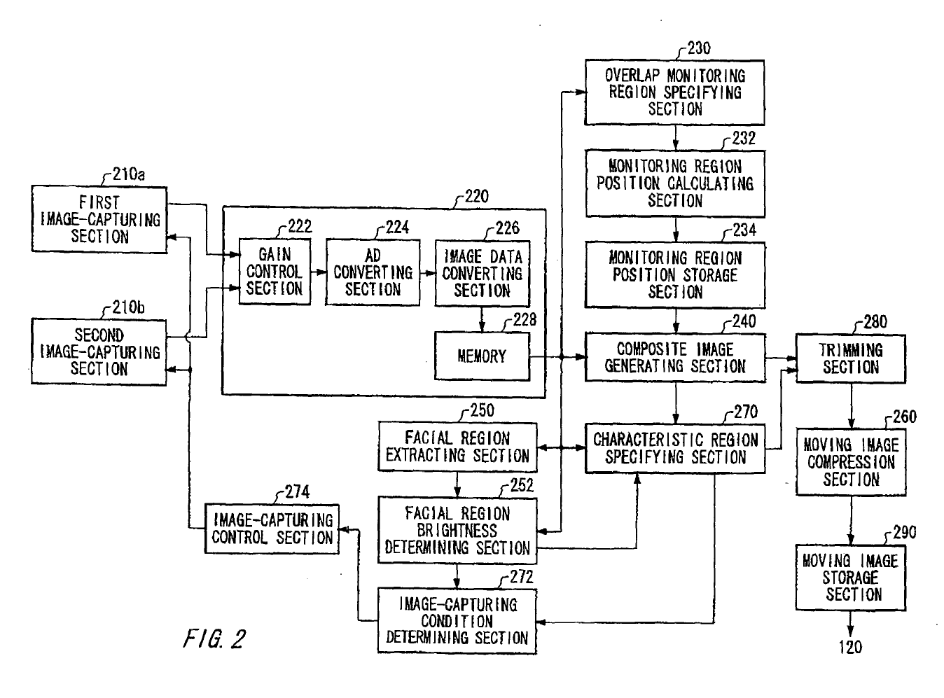

FIG. 2 shows an example of operation blocks when the monitoring apparatus 100 operates in a trimming mode. The monitoring system 100 includes a first image-capturing section 210a, a second image-capturing section 210b, an image processing section 220, an overlap monitoring region specifying section 230, a monitoring region position calculating section 232, a monitoring region position storage section 234, a composite image generating section 240, a facial region extracting section 250, a facial region brightness determining section 252, a moving image compression section 260, a characteristic region specifying section 270, an image-capturing condition determining section 272, an image-capturing control section 274, a trimming section 280, and a moving image storage section 290. The image processing section 220 includes a gain control section 222, an AD converting section 224, an image data converting section 226 and a memory 228. Here, the camera 112a and the camera 112b described with reference to FIG. 1 may operate as the first image-capturing section 210a and the second image-capturing section 210. The image generating apparatus 111 described with reference to FIG. 1 may operate as the image processing section 220, the overlap monitoring region specifying section 230, the monitoring region position calculating section 232, the monitoring region position storage section 234, the composite image generating section 240, the facial region extracting section 250, a facial region brightness determining section 252, the moving image compression section 260, the characteristic region specifying section 270, the image-capturing condition determining section 272, the image-capturing control section 274, the trimming section 280 and the moving image storage section 290.

The first image-capturing section 210a captures a moving image in a first monitoring region. The second image-capturing section 210b captures a moving image in a second image capturing region in synchronism with an image capturing operation in the first monitoring region by the first image-capturing section 210a. For example, the second image-capturing section 210b captures the second monitoring region at a timing the same as that of an image-capturing operation of the first image-capturing section 210a. Here, the first image-capturing section 210a and the second image-capturing section 210b, specifically, may receive light from a subject by a plurality of light receiving elements such as CCDs and generate a first frame image and a second frame image of a moving image, respectively.

Specifically, the monitoring region position storage section 234 stores a relative positional relationship between the first monitoring region captured by the first image-capturing section 210a and the second monitoring region captured by the second image-capturing section 210b. Then, the composite image generating section 240 generates a composite image by adjusting a position at which the first frame image and the second frame image are combined based on the relative positional relationship between the first monitoring region and the second monitoring region, which is stored in the monitoring region position storage section 234.

the composite image generating section 240 generates a composite image by adjusting a position at which the first frame image constituting the moving image captured by the first image-capturing section 210a and the second frame image constituting the moving image captured by the second image-capturing section 210b, respectively based on the relative positional relationship between the first monitoring region captured by the first image-capturing section 210a and the second monitoring region captured by the second image-capturing section 210b. Then, the moving image storage section 290 stores the composite image generated by the composite image generating section 240 as a frame image constituting a moving image in a partial monitoring region including at least a part of the first monitoring region and the second monitoring region. Thereby the monitoring region in a wide range can be monitored by a plurality of image-capturing device.

The overlap monitoring region specifying section 230 matches the first frame image captured by the first image-capturing section 210a with the second frame image captured by the second image-capturing section 210b at the same time as the first image-capturing section 210a captures the first frame image to specify an overlap monitoring region over which the first monitoring region of the first image-capturing section 210a and the second monitoring region of the second image-monitoring section 210b are overlapped. The monitoring region position calculating section 232 calculates the relative positional relationship between the first monitoring region captured by the first image-capturing section 210a and the second monitoring region captured by the second image capturing section 210b based on the overlap monitoring region specified by the overlap monitoring region specifying section 230. Then, the monitoring region position storage section 234 stores the relative positional relationship between the first monitoring region captured by the first image-capturing section 210a and the second monitoring region captured by the second image-capturing section 210b, which is calculated by the monitoring region position calculating section 232.

Then, the composite image generating section 240 generate a composite image by adjusting a position at which the first frame image and the second frame image are combined based on the relative positional relationship between the first monitoring region and the second monitoring region, which is calculated by the monitoring region position calculating section 232. Specifically, the composite image generating section 240 generates a composite image based on the relative positional relationship between the first monitoring region and the second monitoring region, which is calculated by the monitoring region position calculating section 232 and stored in the monitoring region position storage section 234.

Here, the monitoring region position storage section 234 may previously store the relative positional relationship between the first monitoring region captured by the first image-capturing section 210a and the second monitoring region captured by the second image-capturing section 210b. The overlap monitoring region specifying section 230 may regularly specify the overlap monitoring region based on the first fame image captured by the first image-capturing section 210a and the second frame image captured by the second image-capturing section 210b. Then, the monitoring region position calculating section 232 regularly calculates the relative positional relationship between the first monitoring region captured by the first image-capturing section 210a and the second monitoring region captured by the second image-capturing section 210b based on the overlap monitoring region regularly calculated by the overlap monitoring region specifying section 230. Then, the monitoring region position calculating section 232 may regularly calculate the relative positional relationship between the first monitoring region captured by the first image capturing section 210a and the second monitoring region captured by the second image-capturing section 210b and store the same in the monitoring region position storage section 234.

The trimming section 280 trims the composite image generated by the composite image generating section 240 with an aspect ratio the same as that of the first frame image captured by the first image-capturing section 210a or the second frame image captured by the second image-capturing section 210b to extract a partial monitoring region image Here, the trimming section 280 may trim the composite image generated by the composite image generating section 240 with an aspect ratio the same as that of a frame image constituting a moving image reproduced by the external image reproducing apparatus 120 to extract a partial monitoring region image.

Then, the moving image storage section 290 stores the partial monitoring region image extracted by the trimming section 280 as a frame image constituting a moving image in the partial monitoring region. The moving image compression section 260 compresses a plurality of partial monitoring region images extracted by the trimming section 280 into a moving image as frame images constituting the moving image. For example, the moving image compression section 260 compresses the plurality of partial monitoring region images based on the MPEG standard. Then, the moving image storage section 290 stores the plurality of partial monitoring region images compressed by the moving image compression section 260 as a frame image constituting a moving image in the partial monitoring region. As described above, the monitoring apparatus 110 can generate a moving image of a partial region including the subject being important as a monitoring target among a number of monitoring images captured by plurality of image-capturing devices.

Here, the composite image generating section 240 may not actually generate a composite image but virtually generate a composite image Specifically, the composite image generating section 240 may adjust a position at which the first frame image and the second frame image are combined based on the relative positional relationship between the first monitoring region and the second monitoring region, which is calculated by the monitoring region position calculating section 232 and generate a virtual composite image information including the adjusted composite position information corresponding to each of the first frame image and the second frame image. Then, the trimming section 280 may trim from at least one of the first frame image and the second frame image based on the virtual composite image information generated by the composite image generating section 240 to extract the partial monitoring region image.

The image processing section 220 alternately performs an image processing on the first frame image read from the plurality of light receiving elements included in the first image capturing section 210a and the second frame image read from the plurality of light receiving elements included in the second image-capturing section 210b and stores the same in the memory 228. The gain control section 222 may be an AGC (Automatic Gain Control) for example, which converts signals inputted from the first image-capturing section 210a and the second image-capturing section 210b to be at an appropriate signal level for a signal processing at the subsequent stage. Then, the AD converting section 224 alternately converts the first frame image read from the plurality of light receiving elements included in the first image-capturing section 210a and the second frame image read from the plurality of light receiving elements included in the second image-capturing section 210b to digital data. Specifically, the AD converting section 224 converts the signal which has been converted to be at an appropriate signal level by the gain control section 222 to digital data. Then, the composite image generating section 240 generates a composite image by adjusting a position at which the first frame image converted to the digital data by the AD converting section 224 and the second frame image converted to the digital data by the AD converting section 224 are combined.

Additionally, the data converting section 226 alternately converts image data of the first frame image read from the plurality of light receiving elements included in the first image-capturing section 210a and image data of the second frame image read from the plurality of light receiving elements included in the second image-capturing section 210b to display image data. For example, the image data converting section 226 performs a conversion processing such as a gamma correction on the received light intensity of CCDs converted to digital data by the AD converting section 224 to convert the image data to display image data. Then, the composite image generating section 240 generates a composite image by adjusting a position at which the first frame image converted to the display image data by the image data converting section 226 and the second frame image converted to the display image data by the image data converting section 226 are combined.

As described above, the image data captured by the first image-capturing section 210a and the second image-capturing section 210b are processed by the shared image processing section 220, so that the cost of the monitoring apparatus 110 can be reduced in comparison with the case that each of the image capturing devices performs the image processing.

The characteristic region specifying section 270 specifies a characteristic region in the composite image by analyzing the composite image generated by the composite image generating section 240. Then, the trimming section 280 trims the characteristic region image which is an image of the characteristic region specified by the characteristic region specifying section 270 from the composite image generated by the composite image generating section 240 to extract the same. Then, the moving image storage section 290 stores the characteristic region image extracted by the trimming section 280 as a frame image constituting a moving image in a partial monitoring region including at least a part of the first monitoring region and the second monitoring region.

Specifically, the characteristic region specifying section 270 specifies a movement region which is moving in the composite image by analyzing a plurality of composite images generated by the composite image generating section 240. For example, the characteristic region specifying section 270 may specify a movement region from the frame image captured before. Then, the trimming section 280 trims a movement region image which is an image of the movement region specified by the characteristic region specifying section 270 from the composite image generated by the composite image generating section 240 to extract the same. Then, the moving image storage section 290 stores the movement region image extracted by the trimming section 280 as a frame image constituting the moving image in the partial monitoring region. Therefore, the monitoring apparatus 110 can appropriately monitor the image region including the moving subject as an important monitoring target region.

Additionally, the characteristic region specifying section 270 specifies a person region where there is any person in the composite image by analyzing the composite image generated by the composite image generating section 240. Then, the trimming section 280 trims a person region image which is an image in the person region specified by the characteristic region specifying section 270 to extract the same. Then, the moving image storage section 290 stores the person region image extracted by the trimming section 280 as a frame image constituting the moving image in the partial monitoring region. Therefore, the monitoring apparatus 110 can appropriately monitor the image region including the person as an important monitoring target region

Here, the trimming section 280 may trim the characteristic region image of which aspect ratio is the same as that of the first frame image captured by the first image-capturing section 210a or and the second frame image captured by the second image-capturing section 210b, or the characteristic region image of which aspect ratio is the same as that of a frame image constituting the moving image reproduced by the external image reproducing apparatus 120 to extract the same. Then, the moving image storage section 290 stores the characteristic region image extracted by the trimming section 280 as a frame image constituting the moving image in the characteristic region. Therefore, the monitoring apparatus 110 can record a frame image on which an important monitoring target region is shown with the aspect ratio appropriate for monitoring.

The moving image compression section 260 may compress the plurality of characteristic region images extracted by the trimming section 280 into a moving image as frame images constituting the moving image. The moving image storage section 290 may store the plurality of characteristic region images compressed by the moving image compression section 260 as frame images constituting the moving image in the characteristic region.

The image control section 274 matches the image-capturing condition of the first image-capturing section 210a with the image-capturing condition of the second image-capturing section 210b. Then, the composite image generating section 240 generates a composite image by adjusting a position at which the first frame image constituting the moving image captured by the first image-capturing section 210a and the second frame image constituting the moving image captured by the second image-capturing section 210b, respectively under the same image-capturing condition controlled by the image-capturing control section 274 based on the relative positional relationship between the first monitoring region captured by the first image-capturing section 210a and the second monitoring region captured by the second image-capturing section 210b Here, the composite image generating section 240 generates a composite image by adjusting a position at which the first frame image and the second frame image are combined based on the positional relationship between the first monitoring region and the second monitoring region as described above.

The characteristic region specifying section 270 specifies the characteristic region in the whole monitoring region 170 including the first monitoring region and the second monitoring region based on the moving image captured by each of the first image-capturing section 210a and the second image-capturing section 210b. Then, the image-capturing condition determining section 272 determines the image-capturing condition of the first image-capturing section 210a and the second image-capturing section 210b based on the image in the characteristic region specified by the characteristic region specifying section 270. Then, the image-capturing control section 274 causes the first image-capturing section 210a and the second image-capturing section 210b to capture the moving images under the image-capturing condition determined by the image-capturing condition determining section 272.

Specifically, the characteristic region specifying section 270 specifies a movement region which is moving as the characteristic region based on the moving image captured by each of the first image-capturing section 210a and the second image-capturing section 210b. Here, the characteristic region specifying section 270 may specify the movement region where the movement is largest when there is a plurality of movement regions in the whole monitoring region 170.

Then, the image-capturing condition determining section 272 determines the exposure condition of the first image-capturing section 210a and the second image-capturing section 210b based on the first frame image of the first monitoring region captured by the first image-capturing section 210a, which includes the movement region specified by the characteristic region specifying section 270 Then, the image-capturing control section 274 causes the first image-capturing section 210a and the second image-capturing section 210b to capture the moving images under the exposure condition determined by the image-capturing condition determining section 272

The characteristic region specifying section 210 may specify the person region where there is any person based on the moving image captured by each of the first image-capturing section 210a and the second image-capturing section 210b. Then, the image-capturing condition determining section 272 determines the exposure condition of the first image-capturing section 210a and the second image-capturing section 210b based on the first frame image of the first monitoring region captured by the first image-capturing section 210a, which includes the person region specified by the characteristic region specifying section 270. Then, the image-capturing control section 274 causes the first image-capturing section 210a and the second image-capturing section 210b to capture the moving images under the exposure condition determined by the image-capturing condition determining section 272.

When there are a plurality of person regions in the whole monitoring region 170, the characteristic region specifying section 270 specifies the person region in which the area ratio of the person to the whole monitoring region 170 is largest. Then, the image-capturing condition determining section 272 determines the exposure condition of the first image-capturing section 210a and the second image-capturing section 210b based on the first frame image of the first monitoring region captured by the first image-capturing section 210a, which includes the person region specified by the characteristic region specifying section 270. Then, the image-capturing control section 274 causes the first image-capturing section 210a and the second image-capturing section 210b to capture the moving images under the exposure condition determined by the image-capturing condition determining section 272. Therefore, the monitoring apparatus 110 can appropriately monitor a person who breaks into the monitoring region 170.

The facial region extracting section 250 extracts a facial region which is a region of the face of any person in the whole image monitoring section 170 based on the moving image captured by each of the first image-capturing section 210a and the second image-capturing section 210b. Then, the facial region brightness determining section 252 determines the brightness of the facial region extracted by the facial region extracting section 250. Here, when there are a plurality of person regions in the whole monitoring region 170, the characteristic region specifying section 270 specifies the person region in which the brightness of the person determined by the facial region brightness determining section 252 is within a predetermined value. Additionally, when there are a plurality of person regions in the whole monitoring region 170, the characteristic region specifying section 270 may specify the person region where it is determined by the facial region brightness determining section 252 that the person is most brightly shown.

The image-capturing condition determining section 272 determines the exposure condition of the first image-capturing section 210a and the second image-capturing section 210b based on the first frame image of the first monitoring region captured by the first image-capturing section 210a, which includes the person region specified by the characteristic region specifying section 270. Then, the image-capturing control section 274 causes the first image-capturing section 210a and the second image-capturing section 210b to capture the moving images under the exposure condition determined by the image-capturing condition determining section 272. Here, the exposure condition may include at least one of the diaphragm or the exposure time of the first image-capturing section 210a and the second image-capturing section 210b.

As described above, the monitoring apparatus 110 adjusts the image-capturing condition of the other camera 112 to the image-capturing condition of a camera being capable of appropriately capturing a subject which is important as a monitoring target. Therefore, visually unified frame images can be generated.

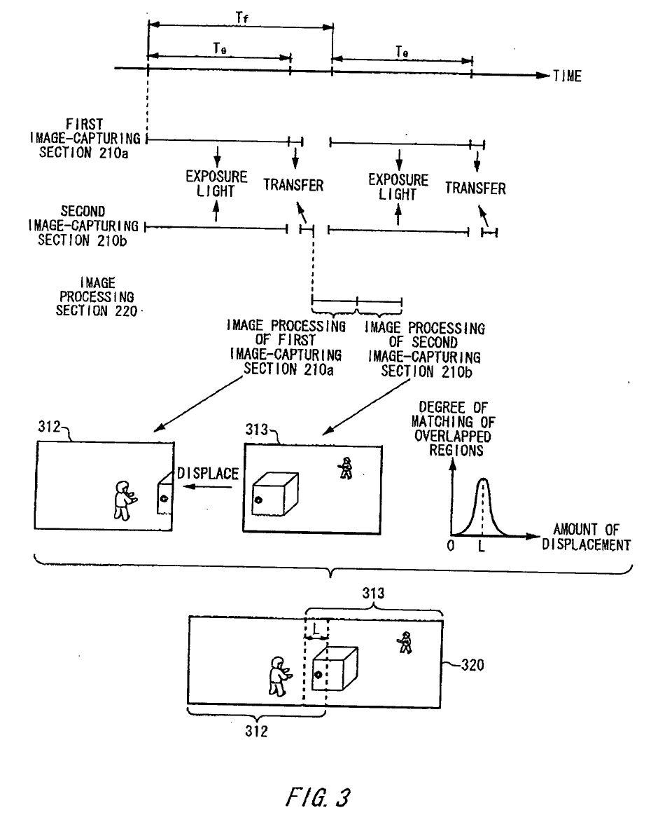

FIG. 3 shows an example of image-capturing process of a monitoring region by the monitoring apparatus 110. The monitoring apparatus 110 acquires a frame image at a predetermined frame period Tf. At this time, the first image-capturing section 210a and the second image-capturing section 210b is exposed to light for a predetermined exposure time Te, and a charge according to the amount of light is accumulated. Then, the first image-capturing section 210a and the second image-capturing section 210b sequentially transfer the accumulated charge to the gain control section 222 of the image processing section 220 after the exposure period is terminated. Then, after generating a first frame image 312 in the first monitoring region based on the charge transferred from the first image-capturing section 210a, the image processing section 220 generates a second frame image 313 in the second monitoring region based on the charge transferred from the second image-capturing section 210b and stores the same in the memory 228. Here, the image processing section 220 may cause the memory to store data transferred from the first image-capturing section 210a to the gain control section 222 at a time when the data is converted to digital data by the AD converting section 224 and then, cause the second image-capturing section 210 to start to transfer the data to the gain control section 222 before the image data converting section 226 performs an image conversion processing on the data transferred from the image-capturing section 210a.

Then, the overlap monitoring region specifying section 230 calculates a degree of matching of images in the region over which the first frame image 312 and the second frame image 313 are overlapped when the second frame image 313 is displaced with the first frame image 312. Then, the overlap monitoring region specifying section 230 calculates the degree of matching of images per predetermined amount of displacement.

For example, the overlap monitoring region specifying section 230 longitudinally displaces the second frame image 312 from the end of the frame image 313 in the longitudinal direction of the first frame image 312. Then, the overlap monitoring region specifying section 230 matches the images in the region over which the images are overlapped and calculates the degree of matching of the images as the degree of matching of the frame images. Here, the degree of matching of images may be a value based on the ratio of the area of the part in which the objects included in an image region over which the frame images are overlapped each other to the area of the image region. Additionally, the degree of matching of images may be a value based on the average value of intensity of each pixel in the difference image in the region over which the frame images are overlapped.

Then, the overlap monitoring region specifying section 230 calculates an amount of displacement L which provides the maximum degree of matching. Then, the overlap monitoring region specifying section 230 specifies an overlap monitoring region based on the direction to which the image is displaced and the amount of displacement L. Hereinbefore, an example of operation such that the overlap monitoring region is specified by longitudinally displacing the first frame image has been described for ease of explanation. However, the direction to which the second frame image is displaced is not limited to a longitudinal direction, of course. For example, the overlap monitoring region specifying section 230 may calculate the overlap monitoring region by displacing the second frame image per predetermined amount of displacement along any direction such as the longitudinal direction or the lateral direction of the first frame image. The subject position change calculating section 204 may specify the overlap image region by changing the predetermined amount of displacement in two directions different from each other such as the longitudinal direction or the lateral direction of the first frame image at the same time.

Then, the monitoring region position calculating section 232 calculates a relative coordinate value between the central coordinate of the image-capturing region in the first frame image 312 and the central coordinate of the image-capturing region in the second frame image 312 as the relative positional relationship between the first monitoring region and the second monitoring region. Additionally, the monitoring region position calculating section 232 may calculate each of the relative coordinate value between opposing corners of a rectangle of the region captured by the first frame image 312 and the relative coordinate value between opposing corners of a rectangle of the region captured by the second frame image 313 as the relative positional relation ship between the first monitoring region and the second monitoring region.

Then, the monitoring region position storage section 234 stores the relative relationship between the first monitoring region and the second monitoring region, which is calculated by the monitoring region position calculating section 232. Here, the relative position calculating process as described above may perform every time each frame image is captured, and also may regularly perform at a predetermined period. Additionally, the relative position calculating process may perform at a time when the monitoring apparatus 100 is installed. Additionally, the monitoring apparatus 110 may regularly calculate the relative positional relationship between the first monitoring region and the second monitoring region at a predetermined period based on each frame image captured, and compare the calculated positional relationship with the relative positional relationship between the first monitoring region and the second monitoring region, which is stored in the monitoring region position storage section 234. Then, the monitoring apparatus 110 may issue a message indicating that the positional relationship stored in the monitoring region position storage section 234 is different from an actual positional relationship when the degree of matching between the calculated positional relationship and the positional relationship stored in the monitoring region position storage section 234 is lower than a predetermined degree of matching.

Then, the composite image generating section 240 adjusts the position at which the first frame image 312 and the second frame image 313 are combined without overlapping the image regions on which the overlap monitoring region is shown based on the positional relationship stored in the monitoring region position storage section 234 to generate a composite image 320. As described above, the monitoring system 100 can appropriately combine images from the plurality of cameras 112.

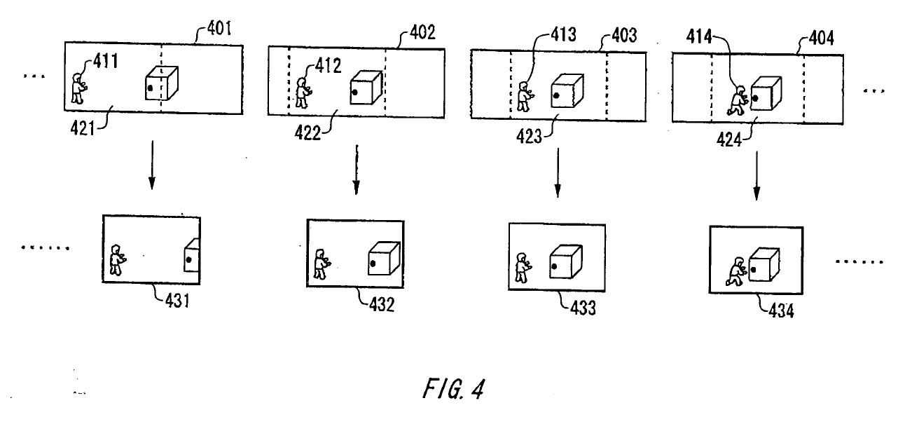

FIG. 4 shows an example of processing to trim characteristic region images from composite images by the trimming section 280. The characteristic region specifying section 270 specifies image regions 411, 412, 413 and 414 which include any moving person from composite images 401, 402, 403 and 404 as characteristic regions, for example. Then, the trimming section 280 trims characteristic region images 421, 422, 423 and 424 each of which size is within one frame image of a moving image including the characteristic regions 411, 412, 413 and 414 as partial monitoring region images, respectively Then, the moving image storage section 290 stores each of the trimmed partial monitoring region image as frame images 431, 432, 433 and 434 to be transmitted to the image reproducing apparatus 120.

Here, the characteristic region specifying section 270 may specify an image region including any person by extracting the outline of a subject using an image processing such as an edge extraction on the frame image and matching the extracted outline of the subject with the pattern of a predetermined person i.e. pattern-matching. Additionally, the characteristic region specifying section 270 may calculate the movement of the subject based on the position on the image of the subject included in each of a plurality of frame images which are continuously captured.

Here, the trimming section 280 may trim the partial monitoring region image from the composite image so as to include a predetermined important monitoring region in the monitoring region 170. Additionally, when the characteristic region specifying section 270 specifies a moving subject as a characteristic region, the trimming section 280 may determine a trimming range such that the image region in the direction to which the subject moves is included in the partial monitoring region image. Additionally, when the size of the partial monitoring region image is larger than that of the frame image, the trimming section 280 may fall the partial monitoring region image within the frame image by performing an image processing such as an affine transformation on the trimmed partial monitoring region image.

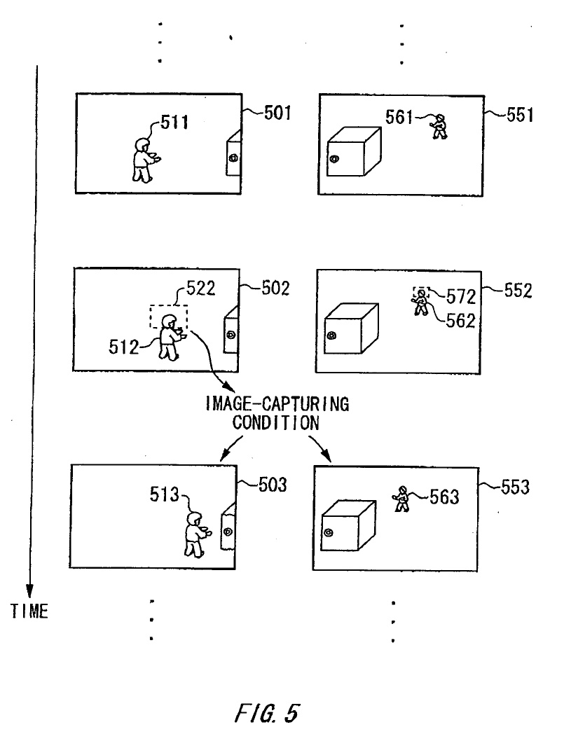

FIG. 5 shows an example of processing to match the image capturing condition between the first image-capturing section 210a and the second image-capturing section 210b. The first image-capturing section 210a captures first frame images 501, 502 and 503. The second image-capturing section 210b captures second frame images 551, 552 and 553, respectively at a thing the same as the time when each of the first frame images is captured. At this time, the characteristic region specifying section 270 specifies such as the image regions 511 and 512 including any moving person among the first frame images 501 and 502 continuously captured by the first image-capturing section 210a as characteristic regions. Additionally, the characteristic region specifying section 270 specifies such as image regions 561 and 562 including any moving person among second frame images 551 and 555 continuously captured by the second image-capturing section 210b as characteristic regions.

Then, when the first frame image 503 and the second frame image 553 are captured, the image-capturing condition determining section 272 matches the image-capturing condition of the second image-capturing section 210b with that of the first image-capturing section 210a for capturing the frame image 503, which captured the frame image 502 including a characteristic region 512 having the largest area among the first frame image 502 and the second frame image 552 captured at the timing before capturing the first frame image 503 and the second frame image 553, so that the second frame image 553 can be obtained.

Here, when the characteristic region specifying section 270 specifies the characteristic regions 512 and 562 including any person, the facial region extracting section 250 specifies facial regions 522 and 572 by extracting flesh-colored regions in the characteristic region, for example. Then, the facial region brightness determining section 252 calculates the brightness of the images of the facial regions 522 and 572 based on the average value of the intensity for each pixel of the image of the facial regions 522 and 572. Then, the characteristic region specifying section 270 matches the image-capturing condition of the second image-capturing section 210b with the image-capturing condition of the first image-capturing section 210a which captured the frame image such as the first frame image 502 including the facial region such as the facial region 522 where the maximum brightness is calculated. At this time, the image-capturing condition determining section 272 may set the image-capturing condition including an exposure condition that the first image-capturing section 210a can appropriately capture the subject in the facial region 522.

Additionally, when the frame images 503 and 553 are captured, the image-capturing condition determining section 272 matches the image-capturing condition of the second image-capturing section 210b with that of the first image-capturing section 210a for capturing the frame image 503, which captured the frame image 502 in which characteristic regions 511 and 512 being more widely moving are specified among a plurality of frame images such as first frame images 501 and 551 and the second frame images 502 and 552, which are captured before capturing the frame images 503 and 553.

Here, the image-capturing condition determining section 272 may store subject characteristic information such as a shape of the subject included in the region specified as the characteristic region at the earliest timing in association with a characteristic region capturing timing at which the subject is captured, and match the image-capturing condition of the second image-capturing section 210b with the image capturing condition of the first image-capturing section 210a which captured the subject corresponding to the subject characteristic information stored in association with the earliest characteristic region capturing timing. Thereby in the monitoring system 100, the monitoring apparatus 110 captures images under the condition being capable of appropriately capturing any person who firstly break into the monitoring region 170, so that the person can be appropriately monitored.

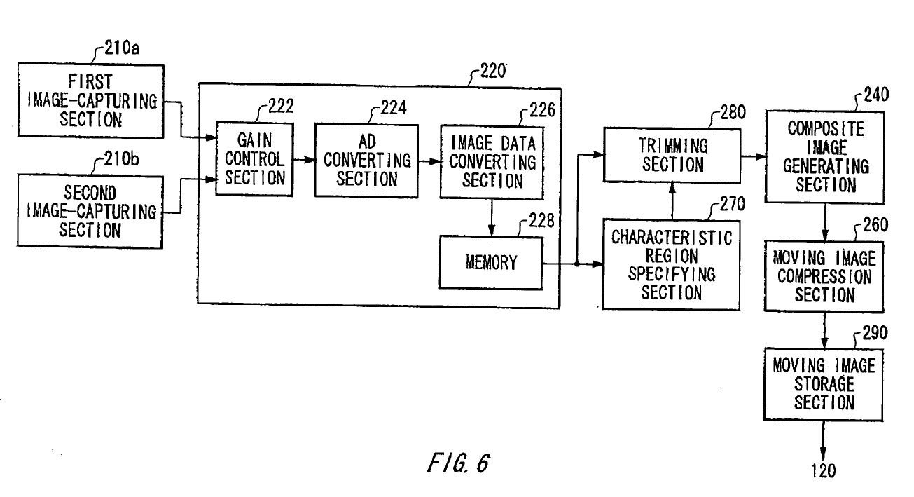

FIG. 6 shows an example of operation blocks when the monitoring apparatus 110 operates in a connecting mode. In the connecting mode according to the present embodiment, the monitoring apparatus 110 includes the first image-capturing section 210a, the second image-capturing section 210b, the image processing section 220, the composite image generating section 240, the moving image compression section 260, the characteristic region specifying section 270, the trimming section 280 and the moving image storage section 290. The image processing section 220 includes the gain control section 222, the AD converting section 224, the image data converting section 226 and the memory 228. Here, each component of the first image-capturing section 210a, the second image-capturing section 210b and the image processing section 220 has the operation and the function the same as the component having the reference numeral the same as that in FIG. 2, so that the description is omitted. Here, when a frame image is generated in the connecting mode, the image-capturing condition of the first image-capturing section 210a and the second image-capturing section 210b may be set for each of the image-capturing sections.

The characteristic region specifying section 270 specifies the characteristic region in the whole monitoring region 170 including the first monitoring region and the second monitoring region based on the moving image captured by each of the first image-capturing section 210a and the second image-capturing section 210b. Specifically, the characteristic region specifying section 270 specifies the characteristic region based on the first frame image and the second frame image converted to digital data by the AD converting section 224. More specifically, the characteristic region specifying section 270 specifies the characteristic region based on the first frame image and the second frame image converted to display image data by the image data converting section 226.

Then, the trimming section 280 trims a plurality of characteristic region images each of which includes the plurality of characteristic regions specified by the characteristic region specifying section 270 from the first frame image constituting the moving image captured by the image-capturing section 210a or the second frame image constituting the moving image captured by the second image-capturing section 210b to extract the same. Then, the composite image generating section 240 generates a composite image obtained by combining the plurality of characteristic region images extracted by the trimming section 280.

Then, the moving image storage section 290 stores the composite image generated by the composite image generating section 240 as the frame images constituting a moving image in the partial monitoring region including at least a part of the first monitoring region and the second monitoring region Therefore, even if there is an important monitoring target in any region other than the first monitoring region captured by the first image-capturing section 210a, for example, a plurality of monitoring targets can be fallen within one frame image and transmitted to the image reproducing apparatus 120.

The characteristic region specifying section 270 specifies a movement region which is moving as the characteristic region based on the moving image captured by each of the first image-capturing section 210a and the second image-capturing section 210b. Then, the trimming section 280 trims a movement region image including the plurality of movement regions specified by the characteristic region specifying section 270 from the first frame image constituting the moving image captured by the image-capturing section 210a or the second frame image constituting the moving image captured by the second image-capturing section 210b to extract the same.

The characteristic region specifying section 270 specifies a person region where there is any person as a characteristic region based on the moving image captured by each of the first image-capturing section 210a and the second image-capturing section 210b. Then, the trimming section 280 trims a person region image which is an image including a plurality of person regions specified by the characteristic region specifying section 270 from the first frame image constituting the moving image captured by the image-capturing section 210a or the second frame image constituting the moving image captured by the second image-capturing section 710b to extract the same.

The trimming section 280 trims a characteristic region image including the characteristic region specified by the characteristic region specifying section 270 such that the aspect ratio of the composite image generated by the composite image generating section 240 is the same as that of the first frame image captured by the first image-capturing section 210a or the second frame image captured by the second-image-capturing section 210b to extract the same. The trimming section 280 may trim the characteristic region image including the characteristic region specified by the characteristic region specifying section 270 such that the aspect ratio of the composite image generated by the composite image generating section 240 is the same as that of a frame image constituting a moving image reproduced by the external image reproducing apparatus 120. Then, the moving image storage section 290 stores partial monitoring region images extracted by the trimming section 280 as five images constituting a moving image in the partial monitoring region.

The moving image compression section 260 compresses the plurality of characteristic region images extracted by the trimming section 280 into a moving image as frame images constituting the moving image. For example, the moving image compression section 260 compresses the plurality of characteristic region images based on the MPEG standard. Then, the moving image storage section 290 stores the plurality of characteristic region images compressed by the moving image compression section 260 into a moving image as frame images constituting the moving image in the partial monitoring region.

Here, when the monitoring apparatus 110 generates frame images in the connecting mode, the trimming section 280 may trim with the aspect ratio the same as that for the trimming mode in which the frame images are trimmed from the composite image. Thereby even if an operation mode for generating frame images is changed temporally between the trimming mode and the connecting mode, the monitoring image can be prevented from being difficult for an observer to observe because of changing the aspect ratio.

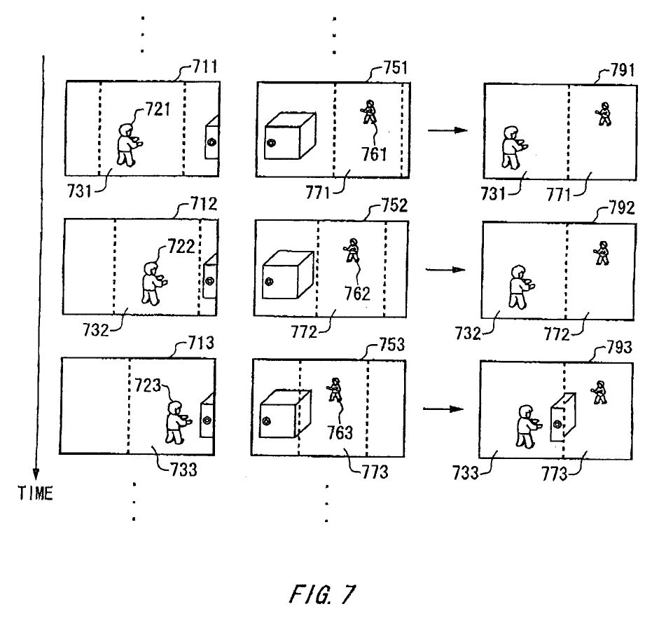

FIG. 7 shows an example of frame image generated by the monitoring apparatus 110 in the connecting mode. The characteristic region specifying section 270 specifies characteristic regions 721, 722 and 723 from the first frame images 711, 712 and 713 captured by the first image-capturing section 210a, respectively. Additionally, the characteristic region specifying section 270 specifies characteristic regions 761, 762 and 763 from the second frame images 751, 752 and 753 captured by the second image-capturing section 210a, respectively. Here, a method of specifying characteristic regions by the characteristic region specifying section 270 may be the same as the method described with reference to FIG. 4, so that the description id omitted.

The trimming section 280 trims characteristic region images 731 and 771 including the characteristic region 721 included in the first frame image 711, and a characteristic region 761 included in the second frame image 751. At this time, the trimming section 280 may trim the characteristic region images 731 and 771 such that the aspect ratio for each of the characteristic region images 731 and 771 is the same as that of a moving image displayed by the image reproducing apparatus 120. Here, the trimming section 280 may trim larger image region including the characteristic region when the area of the characteristic region is larger. Additionally, when the characteristic region specifying section 270 specifies a moving subject as the characteristic region, the trimming section 280 may trim an image region including the monitoring region in a direction to which the subject moves. Further, when the characteristic region specifying section 270 specifies a moving subject as the characteristic region, the trimming section 280 may trim a larger image region including the characteristic region provided that the movement speed is higher. Still more, when the characteristic region specifying section 270 specifies a moving subject as the characteristic region, the trimming section 280 may trim a larger image region including the characteristic region provided that the subject moves more speedily over the own area.

Here, when the size of the image obtained by connecting a plurality of characteristic region images are larger than the size of the moving image reproduced by the image reproducing apparatus 120, the trimming section 280 may perform an image processing such as an affine transformation on each of the trimmed characteristic region images so as to fall the connected image within the moving image.

As described above, since the monitoring apparatus 110 generates frame images in the connecting mode, a predetermined monitoring target region such as a cashbox and any person who breaks into the monitoring region 170 can be fallen within the same frame image. Accordingly, the monitoring system 100 can reduce the amount of data of the moving image transmitted from the monitoring apparatus 110.

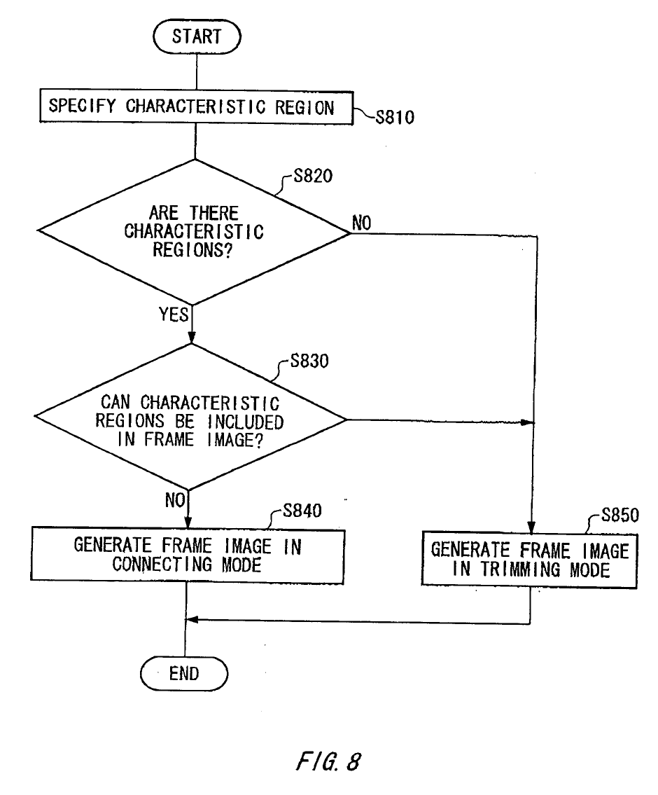

FIG. 8 shows an example of flow chart of selecting an operation mode to generate a frame image by the monitoring apparatus 110. The characteristic region specifying section 270 specifies a characteristic region from each of images captured by the first image-capturing section 210a and the second image-capturing section 210b at the same timing (S810). Then, the monitoring apparatus 110 determines whether the characteristic region specifying section 270 specifies the plurality of characteristic regions (S820). When the characteristic region specifying section 270 specifies a plurality of characteristic regions in the S820, the monitoring apparatus 110 determines whether the plurality of characteristic regions specified by the characteristic region specifying section 270 can be fallen within a partial monitoring image with the aspect ratio trimmed by the trimming section 280 (S830).

When the plurality of characteristic regions specified by the characteristic region specifying section 270 can be fallen within the partial monitoring image with the aspect ratio trimmed by the trimming section 280 in the S830, a composite image will be generated in the connecting mode (S840). In the S820, when the characteristic region specifying section 270 does not specify a plurality of characteristic regions, or the plurality of characteristic regions specified by the characteristic region specifying section 270 can not be fallen within a partial monitoring image with the aspect ratio trimmed by the trimming section 280, a composite image will be generated in the trimming mode (S850). As described above, the monitoring apparatus 110 can appropriately select the trimming mode or the connecting mode dependent on the position of the important monitoring target in the monitoring region 170, the range in which there is the important monitoring target and so forth.

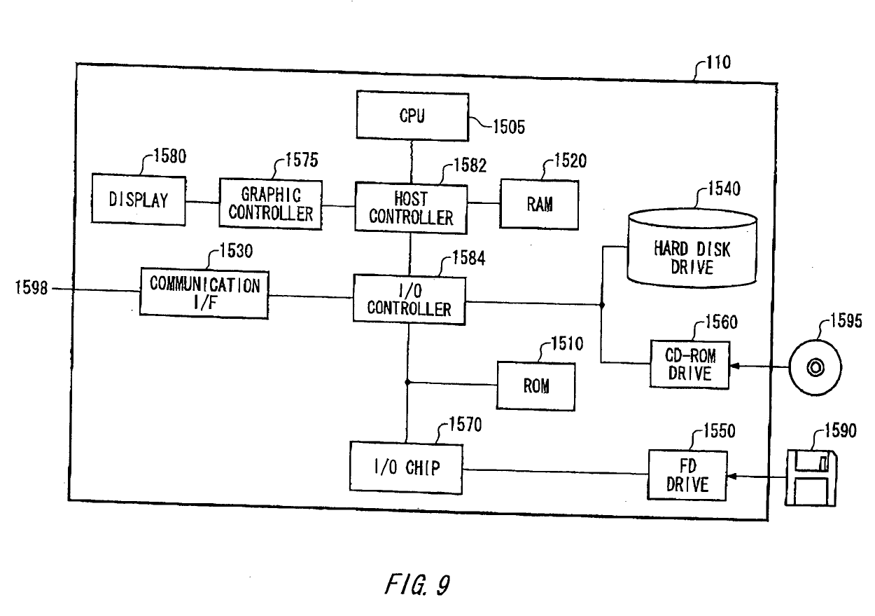

FIG. 9 shows an example of hardware configuration of the monitoring apparatus 110. The monitoring apparatus 110 includes a CPU periphery having a CPU 1505, a RAM 1520, a graphic controller 1575 and a display 1580 which are connected through a host controller 1582 each other, an input/output unit having a communication interface 1530, a hard disk drive 1540 and a CD-ROM drive 1560 which are connected to the host controller 1582 through an input/output controller 1584 and a legacy input/output unit having a ROM 1510, a flexible disk drive 1550 and an input/output chip 1570 which are connected to the input/output controller 1584.

The host controller 1582 connects the RAM 1520 to the CPU 1505 and the graphic controller 1575 which access the RAM 1520 with a high transfer ratio The CPU 1505 operates according to the programs stored in the ROM 1510 and the RAM 1520 to control each unit. The graphic controller 1575 obtains image data generated on a frame buffer provided in the RAM 1520 by the CPU 1505 and displays the same on the display 1580. Alternatively, the graphic controller 1575 may include therein a frame buffer for storing image data generated by the CPU 1505.

The input/output controller 1584 connects the host controller 1582 to the hard disk drive 1540, the communication interface 1530 and the CD-ROM drive 1560 which are relatively high-speed input/output units. The hard disk drive 1540 stores the program and data used by the CPU 1505 in the monitoring apparatus 10. The communication interface 1530 connects to a network communication device 1598 to transmit/receive programs and data. The CD-ROM drive 1560 reads the program or data from the CD-ROM 1595 and provides the same to the hard disk drive 1540 through the RAM 1520.

The ROM 1510, and the flexible disk drive 1550 and input/output chip 1570 which are relatively low-speed input/output units are connected to the input/output controller 1584. The ROM 1510 stores a boot program executed by the monitoring apparatus 110 at activating and a program depending on the hardware of the monitoring apparatus 110. The flexible disk drive 1550 reads the programs or data from a flexible disk 1590 and provides the same to the hard disk drive 1540 and the communication interface 1530 through the RAM 1520. The input/output chip 1570 connects various input/output units through the flexible disk drive 1550 and such as a parallel port, a serial port, a keyboard port and a mouse port.

The program executed by the CPU 1505 is stored in a recording medium, such as the flexible disk 1590, the CD-ROM 1595, or an IC card and provided by the user. The program stored on the recording medium may be compressed or not be compressed. The program is installed from the recording medium to the hard disk drive 1540, read to the RAM 1520 and executed by the CPU 1505.

The program executed by the CPU 1505 causes the monitoring apparatus 110 to function as the first image-capturing section 210a, the second image-capturing section 210b, the image processing section 220, the overlap monitoring region specifying section 230, the monitoring region position calculating section 232, the monitoring region position storage section 234, the composite image generating section 240, the facial region extracting section 250, the facial region brightness determining section 252, the moving image compression section 260, the characteristic region specifying section 270, the image-capturing condition determining section 272, the image-capturing control section 274, the trimming section 280 and the moving image storage section 290 which are described with reference to FIG. 1-FIG. 8. Additionally, the program executed by the CPU 1505 causes the image processing section 220 to function as the gain control section 222, the AD converting section 224, the image data converting section 226 and the memory 228 which are described with reference to FIG. 1-FIG. 8.

The above-described program may be stored in an external storage medium. The recording medium may be, in addition to the flexible disk 1590 and the CD-ROM 1595, an optical storage medium such as a DVD and a PD, a magneto-optical recording medium such as a MD, a tape medium and a semiconductor memory such as an IC card. Additionally, a storage medium such as a hard disk or a RAM which is provided in the server system connected to a private communication network or Internet is used as the recording medium to provide the program to the monitoring apparatus 110 through the network.

While the present invention has been described with the embodiment, the technical scope of the invention not limited to the above described embodiment. It is apparent to persons skilled in the art that various alternations and improvements can be added to the above-described embodiment. It is apparent from the scope of the claims that the embodiment added such alternation or improvements can be included in the technical scope of the invention.

What is claimed is:

1. A monitoring system comprising:
a first image-capturing section that captures a moving image in a first monitoring region;
a second image-capturing section that captures a moving image in a second monitoring region adjacent to the first monitoring region in synchronism with capturing the image in the first monitoring region by the first image-capturing section,
an image-capturing control section that matches an image-capturing condition of the first image capturing section with an image-capturing condition of the second capturing section;
a composite image generating section that generates a composite image by adjusting a position at which a first frame image constituting the moving image captured by the first image-capturing section and a second frame image constituting the moving image captured by the second image-capturing section, respectively under the same image-capturing condition controlled by the image capturing control section based on a relative positional relationship between the first monitoring region by the first image-capturing section and the second monitoring region captured by the second image-capturing section, and
a moving image storing section that stores therein the composite image generated by the composite image generating section as a frame image constituting a moving image in a partial monitoring region including at least a part of the first monitoring region and the second monitoring region.

2. The monitoring system as set forth in claim 1 further comp sing:
a characteristic region specifying section that specifies the characteristic region in the whole monitoring region including the first monitoring region and the second monitoring region based on the moving image captured by each of the first image-capturing section and the second image-capturing section;
an image-capturing condition determining section that determines an image capturing condition for each of the first image-capturing section and the second image-capturing section based on the image in the characteristic region specified by the characteristic region specifying section,
the image-capturing control section causes the first image-capturing section and the second image-capturing section to capture the moving image under the image-capturing condition determined by the image-capturing condition determining section.

3. The monitoring system as set forth in claim 2, wherein
the characteristic region specifying section specifies a movement region which is moving based on the moving image captured by each of the first image-capturing section and the second image-capturing section,
the image-capturing condition determining section determines an exposure condition for each of the first image-capturing section and the second image-capturing section based on the first frame image of the first monitoring region captured by the first image-capturing section 210a, which includes the movement region specified by the characteristic region specifying section, and
the image-capturing control section causes the first image-capturing section and the second image-capturing section to capture the moving image tinder the exposure condition determined by the image-capturing condition determining section.

4. The monitoring system as set forth in claim 3, wherein
the characteristic region specifying section specifies the movement region which is most widely moving when there are a plurality of movement regions in the whole monitoring region,
the image-capturing condition determining section determines the exposure condition of the first image-capturing section and the second image-capturing section based on the first frame image of the first monitoring region captured by the first image-capturing section 210a, which includes the movement region specified by the characteristic region specifying section, and
the image-capturing control section causes the first image-capturing section and the second image-capturing section to capture the moving image under the exposure condition determined by the image-capturing condition determining section.

5. The monitoring system as set forth in claim 2, wherein
the characteristic region specifying section specifies a person region where there is any person as the characteristic region based on the moving image captured by each of the first image-capturing section and the second image-capturing section,
the image-capturing condition determining section determines the exposure condition of the first image-capturing section and the second image-capturing section based on the first frame image of the first monitoring region captured by the first image-capturing section 210a, which includes the person region specified by the characteristic region specifying section, and
the image-capturing control section causes the first image-capturing section and the second image-capturing section to capture the moving image under the exposure condition determined by the image-capturing condition determining section.

6. The monitoring system as set forth in claim 5, wherein
the characteristic region specifying section specifies the person region of which area ratio of the person to the whole monitoring region is largest when there are a plurality of person regions in the whole monitoring region,
the image-capturing condition determining section determines the exposure condition of the first image-capturing section and the second image-capturing section based on the first frame image of the first monitoring region captured by the first image-capturing section 210a, which includes the person region specified by the characteristic region specifying section, and
the image-capturing control section causes the first image-capturing section and the second image-capturing section to capture the moving image under the exposure condition determined by the image-capturing condition determining section.

7. The monitoring system as set forth in claim 5 further comprising:
a facial region extracting section that extracts a facial region which is a region of the face of the person in the whole monitoring region based on the moving image captured by each of the first image-capturing section and the second image-capturing section; and
a facial region brightness determining section that determines a brightness of the facial region extracted by the facial region extracting section;
the characteristic region specifying section specifies the person region of which brightness determined by the facial region brightness determining section is within a predetermined value when there are a plurality of person regions in the whole monitoring region,
the image-capturing condition determining section determines the exposure condition of the first image-capturing section and the second image-capturing section based on the first frame image of the first monitoring region captured by the first image-capturing section 210a, which includes the person region specified by the characteristic region specifying section, and
the image-capturing control section causes the first image-capturing section and the second image-capturing section to capture the moving image under the exposure condition determined by the image-capturing condition determining section.

8. The monitoring system as set forth in claim 1 further comprising:
a trimming section that trims the composite image generated by the composite image generating section with an aspect ratio the same as that of the first frame image captured by the first image-capturing section or the second frame image captured by the second image-capturing section to extract a partial monitoring region image,
the moving image storage section stores the partial monitoring region image extracted by the trimming section as a frame image constituting the moving image in the partial monitoring region.

9. The monitoring system as set forth in claim 1 further comprising:
a trimming section that trims the composite image generated by the composite image generating section with an aspect ratio the same as that of a frame image constituting a moving image reproduced by an external image reproducing apparatus,
the moving image storage section stores the partial monitoring region image extracted by the trimming section as a frame image constituting the moving image in the partial monitoring region.

10. The monitoring system as set forth in claim 8 further comprising a moving image compression section that compresses a plurality of partial monitoring region images extracted by the trimming section into a moving image as frame images constituting the moving image,
the moving image storage section stores the plurality of monitoring region images compressed by the moving image compression section as frame images constituting the moving image in the partial monitoring region.

11. The monitoring system as set forth in claim 9 further comprising: a moving image compression section that compresses a plurality of partial monitoring region images extracted by the trimming section into a moving image as frame images constituting the moving image,
the moving image storage section stores the plurality of monitoring region images compressed by the moving image compression section as frame images constituting the moving image in the partial monitoring region.

12. The monitoring system as set forth in claim 1 further comprising an image processing section that alternately performs an image processing on the first frame image read from a plurality of light receiving elements included in the first image-capturing section and the second frame image read from a plurality of light receiving elements included in the second image-capturing section and stores the same in a memory.

13. The monitoring system as set forth in claim 12, wherein
the image processing section includes an AD converting section that alternately converts a first frame image read from the plurality of light receiving elements included in the first image-capturing section and the second frame image read from the plurality of light receiving elements included the second image-capturing section to digital data, and
the composite image generating section generates a composite image by adjusting a position at which the first frame image converted to the digital data by the AD converting section and the second frame image converted to the digital data by the AD converting section are combined

14. The monitoring system as set forth in claim 12, wherein
the image processing section includes an image data converting section that alternately converts image data of the first frame image read from the plurality of light receiving elements included in the first image-capturing section and image data of the second frame image read from the plurality of light receiving elements included in the second image-capturing section to display image data, and
the composite image generating section generates a composite image by adjusting a position at which the first frame image converted to the display image data by the image data converting section and the second frame image converted to the display image data by the image data converting section are combined.

15. A monitoring method comprising:
capturing a moving image in a first monitoring region;
capturing a moving image in a second monitoring region adjacent to the first monitoring region in synchronism with capturing the image in the first monitoring region by the first image-capturing section;
matching an image-capturing condition of the first image capturing step with an image-capturing condition of the second image-capturing step;
generating a composite image by adjusting a position at which a first frame image constituting the moving image captured by the first image-capturing step and a second frame image constituting the moving image captured by the second image-capturing step, respectively under the same image-capturing condition controlled by the image-capturing control step based on a relative positional relationship between the first monitoring region captured by the first image capturing step and the second monitoring region captured by the second image-capturing step; and
storing therein the composite image generated by the composite image generating step as a frame image constituting a moving image in a partial monitoring region including at least a part of the first monitoring region and the second monitoring region.

16. A program for a monitoring system that captures moving images, the program operates the monitoring system to function as:
a first image-capturing section that captures a moving image in a first monitoring region,
a second image-capturing section that captures a moving image in a second monitoring region adjacent to the first monitoring region in synchronism with capturing the image in the first monitoring region by the first image-capturing section;
an image-capturing control section that matches an image-capturing condition of the first image capturing section with an image-capturing condition of the second capturing section;
a composite image generating section that generates a composite image by adjusting a position at which a first frame image constituting the moving image captured by the first image-capturing section and a second frame image constituting the moving image captured by the second image-capturing section, respectively under the same image-capturing condition controlled by the image capturing control section based on a relative positional relationship between the first monitoring region by the first image-capturing section and the second monitoring region captured by the second image-capturing section; and
a moving image storing section that stores therein the composite image generated by the composite image generating section as a fame image constituting a moving image in a partial monitoring region including at least a part of the first monitoring region and the second monitoring region.

17. A monitoring system comprising:
a first image-capturing section that captures a moving image in a first monitoring region;
a second image-capturing section that captures a moving image in a second monitoring region adjacent to the first monitoring region in synchronism with capturing the image in the first monitoring region by the first image-capturing section;
a composite image generating section that generates a composite image by adjusting a position at which a first frame image constituting the moving image captured by the first image-capturing section and a second frame image constituting the moving image captured by the second image-capturing section, respectively under the same image-capturing condition controlled by the image capturing control section based on a relative positional relationship between the first monitoring region captured by the first image-capturing section and the second monitoring region captured by the second image-capturing section;
a characteristic region specifying section that specifies a characteristic region in the composite image by analyzing the composite image generated by the composite image generating section;
a trimming section that trims a characteristic region image which is an image in the characteristic region specified by the characteristic region specifying section from the composite image generated by the composite image generating section to extract the same; and
a moving image storing section that stores therein the characteristic region image extracted by the trimming section as a frame image constituting the moving image in a partial monitoring region including at least a part of the first monitoring region and the second monitoring region.

18. The monitoring system as set forth in claim 17, wherein
the characteristic region specifying section specifies a movement region which is moving in a composite image by analyzing a plurality of composite images generated by the composite image generating section,
the trimming section trims a movement region image which is an image in the movement region specified by the characteristic region specifying section from the composite image generated by the composite image generating section, and
the moving image storage section stores the movement region image extracted by the trimming section as a frame image constituting the moving image in the partial monitoring region.

19. The monitoring system as set forth in claim 17, wherein the characteristic region specifying section specifies a person region where there is any person in a composite image by analyzing the composite image generated by the composite image generating section,
the trimming section trims a person region image which is an image in the person region specified by the characteristic region specifying section from the composite image generated by the composite image generating section, and
the moving image storage section stores the person region image extracted by the trimming section as a frame image constituting the partial monitoring region

20. The monitoring system as set forth in claim 17, wherein
the trimming section trims the characteristic region image with an aspect ratio the same as that of the first frame image captured by the first image-capturing section or the second frame image captured by the second image-capturing section from the composite image generated by the composite image generating section,
the moving image storage section stores the moving image in the characteristic region image extracted by the trimming section as a frame image constituting the moving image in the characteristic region.

21. The monitoring system as set forth in claim 17, wherein
the tinning section trims the characteristic region image with an aspect ratio the same as that of a frame image constituting a moving image reproduced by an external image reproducing apparatus from the composite image generated by the composite image generating section to extract the same, and
the moving image storage section stores the characteristic region image extracted by the trimming section as a frame image constituting the moving image in the characteristic region.

22. The monitoring system as set forth in claim 20 further comprising a moving image compressing section that compresses the plurality of characteristic region images extracted by the trimming section into a moving image as frame images constituting the moving image,
the moving image storage section stores the plurality of characteristic region images compressed by the moving image compression section into a moving image as frame images constituting the moving image in the characteristic region.

23. The monitoring system as set forth in claim 21 further comprising a moving image compressing section that compresses the plurality of characteristic region images extracted by the trimming section into a moving image as frame images constituting the moving image,
the moving image storage section stores the plurality of characteristic region images compressed by the moving image compression section into a moving image as frame images constituting the moving image in the characteristic region.

24. The monitoring system as set forth in claim 17 further comprising an image processing section that alternately perform an image processing on the first frame image read from a plurality of light receiving elements included in the first image-capturing section and the second frame image read from a plurality of light receiving elements included in the second image-capturing section and stores the same in a memory.

25. The monitoring system as set forth in claim 24, wherein
the image processing section includes an AD converting section that alternately converts the first frame image read from the plurality of light receiving elements included in the first image-capturing section and the second frame image read from the plurality of light receiving elements included in the second image-capturing section to digital data,
the composite image generating section generates a composite image by adjusting a position at which the first frame image converted to the digital data by the AD converting section and the second frame image converted to the digital data by the AD converting section are combined.

26. The monitoring system as set forth in claim 24, wherein
the image processing section includes an image data converting section that alternately converts image data of the first frame image read from the plurality of light receiving elements included in the first image-capturing section and image data of the second frame image read from the plurality of light receiving elements included in the second image-capturing section to display image data, and
the composite image generating section generates a composite image by adjusting a position at which the first frame image converted to the display image data by the image data converting section and the second fine image converted to the display image data by the image data converting section are combined.

27. A monitoring method comprising
capturing a moving image in a first monitoring region,
capturing a moving image in a second monitoring region adjacent to the first monitoring region in synchronism with capturing the image in the first monitoring region by the first image-capturing step,
generating a composite image by adjusting a position at which a first frame image constituting the moving image captured by the first image-capturing step and a second frame image constituting the moving image captured by the second image-capturing step, respectively based on a relative positional relationship between the first monitoring region by the first image capturing step and the second monitoring region captured by the second image-capturing step;
specifying a characteristic region in the composite image by analyzing the composite image generated by the composite image generating step;
trimming a characteristic region image which is an image in the characteristic region specified by the characteristic region specifying step from the composite image generated by the composite image generating step to extract the same; and
storing the characteristic region image extracted by the trimming step as a frame image constituting the moving image in a partial monitoring region including at least a part of the first monitoring region and the second monitoring region.

28. A program for a monitoring system that captures moving images, the program operates the monitoring system to function as:
a first image-capturing section that captures a moving image in a first monitoring region;
a second image-capturing section that captures a moving image in a second monitoring region adjacent to the first monitoring region in synchronism with capturing the image in the first monitoring region by the first image-capturing section;
an image-capturing control section that matches an image-capturing condition of the first image capturing section with an image-capturing condition of the second capturing section;
a composite image generating section that generates a composite image by adjusting a position at which a first frame image constituting the moving image captured by the first image-capturing section and a second frame image constituting the moving image captured by the second image-capturing section, respectively under the same image-capturing condition controlled by the image capturing control section based on a relative positional relationship between the first monitoring region by the first image-capturing section and the second monitoring region captured by the second image-capturing section; and
a moving image storing section that stores therein the composite image generated by the composite image generating section as a frame image constituting a moving image in a partial monitoring region including at least a part of the first monitoring region and the second monitoring region.

29. A monitoring system comprising:
a first image-capturing section that captures a moving image in a first monitoring region;
a second image-capturing section that captures a moving image in a second monitoring region adjacent to the first monitoring region in synchronism with capturing the image in the first monitoring region by the first image-capturing section;
a characteristic region specifying section that specifies a characteristic region in the whole monitoring region including the first monitoring region and the second monitoring region based on the moving image captured by each of the first image capturing section and the second image capturing section,
a trimming section that trims a plurality of characteristic region images including the plurality of characteristic regions specified by the characteristic region specifying section, respectively from the first frame image constituting the moving image captured by the first image-capturing section or the second frame image constituting the moving image captured by the second image-capturing section, respectively from the first frame image constituting the moving image captured by the first image-capturing section or the second frame image constituting the moving image captured by the second image-capturing section to extract the same;
a composite image generating section that generates a composite image obtained by combining the plurality of characteristic region images extracted by the trimming section; and
a moving image storage section that stores the composite image generated by the composite image generating section as a frame image constituting the moving image in a partial monitoring region including at least a part of the first monitoring region and the second monitoring region.

30. She monitoring system as set forth in claim 29, wherein
the characteristic region specifying section specifies a movement region which is moving as the characteristic region based on the moving image captured by each of the first image-capturing section and the second image-capturing section,
the trimming section trims a movement region image which is an image including the plurality of movement regions specified by the characteristic region specifying section from the first frame image constituting the image captured by the first image-capturing section or the second frame image constituting the moving image captured by the second image-capturing section to extract the same.

31. The monitoring system as set forth in claim 29, wherein
the characteristic region specifying section specifies a person region where there is any person based on the moving image captured by each of the first image-capturing section and the second image-capturing section, and
the trimming section trims a movement region image including the plurality of movement regions specified by the characteristic region specifying section from the first frame image constituting the moving image captured by the first image-capturing section or the second frame image constituting the moving image captured by the second image-capturing section to extract the same

32. The monitoring system as set forth in claim 29, wherein
the trimming section trims the characteristic region image including the characteristic region specified by the characteristic region specifying section such that the aspect ratio of the composite image generated by the composite image generating section is the same as that of the first frame image captured by the first image-capturing section or the second frame image captured by the second image-capturing section to extract the same,
the moving image storage section stores the partial monitoring region image extracted by the trimming image as a frame image constituting the moving image in the partial monitoring region.

33. The monitoring system as set forth in claim 29, wherein
the trimming section trims the characteristic region image including the characteristic region specified by the characteristic region specifying section such that the aspect ratio of the composite image generated by the composite image generating section is the same as that of a frame image constituting a moving image reproduced by an external image reproducing apparatus to extract the same,
the moving image storage section stores the partial monitoring region image extracted by the trimming section as a frame image constituting the moving image in the partial monitoring region.

34. The monitoring system as set forth in claim 32 further comprising a moving image compression section that compresses the plurality of composite images compressed by the moving image compression section into a moving image as frame images constituting the moving image in the partial monitoring region,
the moving image storage section stores the plurality of composite images compressed by the moving image compression section as frame images constituting the moving image in the partial monitoring region.

35. The monitoring system as set forth in claim 33 further comprising a moving image compression section that compresses the plurality of composite images compressed by the moving image compression section into a moving image as frame images constituting the moving image in the partial monitoring region,
the moving image storage section stores the plurality of composite images compressed by the moving image compression section as frame images constituting the moving image in the partial monitoring region.

36. The monitoring system as set forth in claim 29 further comprising an image processing section that alternately performs an image processing on the first frame image read from a plurality of light receiving elements included in the first image-capturing section and the second frame image read from a plurality of light receiving elements included in the second image-capturing section and stores the same in a memory.

37. The monitoring system as set forth in claim 36 further comprising an AD converting section that alternately converts the first frame image read from the plurality of light receiving elements included in the first image-capturing section and the second frame image read from the plurality of light receiving elements included in the second image-capturing section to digital data,
the characteristic region specifying section specifies the characteristic region based on the first frame image and the second frame image converted to the digital data by the AD converting section.

38. The monitoring system as set forth in claim 36 further comprising an image data converting section that alternately converts image data of the first frame image read from the plurality of light receiving elements included in the first image-capturing section and image data of the second frame image read from the plurality of light receiving elements included in the second image-capturing section to display image data,
the characteristic region specifying section specifies the characteristic region based on the first frame image and the second frame image converted to the display image data by the image data converting section.

39. A monitoring method comprising.
capturing a moving image in a first monitoring region;
capturing a moving image in a second monitoring region adjacent to the first monitoring region in synchronism with capturing the image in the first monitoring region by the first image-capturing section;
specifying a characteristic region in the whole monitoring region including the first monitoring region and the second monitoring region based on the moving image captured by each of the first image capturing step and the second image capturing step;
trimming a plurality of characteristic region images including the plurality of characteristic regions specified by the characteristic region specifying step, respectively from the first frame image constituting the moving image captured by the first image-capturing step or the second frame image constituting the moving image captured by the second image-capturing step, respectively;
generating a composite image obtained by combining the plurality of characteristic region images extracted by the trimming step, and
storing the composite image generated by the composite image generating step as a frame image constituting the moving image in a partial monitoring region including at least a part of the first monitoring region and the second monitoring region.

40. A program for a monitoring system that captures moving images, the program operates the monitoring system to function as:
a first image-capturing section that captures a moving image in a first monitoring region;
a second image-capturing section that captures a moving image in a second monitoring region adjacent to the first monitoring region in synchronism with capturing the image in the first monitoring region by the first image-capturing section,
a characteristic region specifying section that specifies a characteristic region in the whole monitoring region including the first monitoring region and the second monitoring region based on the moving image captured by each of the first image capturing section and the second image capturing section;
a trimming section that trims a plurality of characteristic region images including the plurality of characteristic regions specified by the characteristic region specifying section, respectively from the first frame image constituting the moving image captured by the first image-capturing section or the second frame image constituting the moving image captured by the second image-capturing section, respectively from the first frame image constituting the moving image captured by the first image-capturing section or the second frame image constituting the moving image captured by the second image-capturing section to extract the same;
a composite image generating section that generates a composite image obtained by combining the plurality of characteristic region images extracted by the trimming section; and
a moving image storage section that stores the composite image generated by the composite image generating section as a frame image constituting the moving image in a partial monitoring region including at least a part of the first monitoring region and the second monitoring region.
